(19) United States
(12) Patent Application Publication
(10) Pub. No.: US 2017/0060942 A1
(43) Pub. Date: Mar. 2, 2017

(54) Method and Apparatus for Information Presentation Based on Service Object

(71) Applicant: Alibaba Group Holding Limited, Grand Cayman (KY)

(72) Inventors: Zongyu WANG, Hangzhou (CN); Chengfu HUO, Hangzhou (CN); Peng HUANG, Hangzhou (CN)

(21) Appl. No.: 15/242,896

(22) Filed: Aug. 22, 2016

(30) Foreign Application Priority Data
Aug. 25, 2015 (CN) 201510527918.6

(51) Int. Cl. G06F 17/30

(52) U.S. Cl. CPC G06F 17/30442; G06F 17/30483; G06F 17/30554

(57) ABSTRACT

An apparatus and method for information presentation based on a service object. The method includes receiving an adjustment request for a search parameter with respect to a first service object from a client device, the adjustment request including a first parameter value, identifying one or more second parameter values, calculating one or more relationship parameters, wherein calculating one or more relationship parameters includes determining a relationship between the search parameter and one or more actual total presentation quantities of the first service object, calculating one or more estimated total presentation quantities using the first parameter value, the one or more second parameter values, and the one or more relationship parameters, fitting a relationship curve between the search parameter and the one or more estimated total presentation quantities based on the first parameter value, the one or more second parameter values, and the one or more estimated total presentation quantities, and the one or more estimated total presentation quantities, and transmitting the relationship curve to the client device.

### CROSS-REFERENCE TO RELATED APPLICATIONS

This application claims the benefit of priority from Chinese Patent Application No. 201510527918.6, filed on Aug. 25, 2015, entitled “Method and Apparatus for Information Display Based on Service Object,” which is incorporated herein by reference in its entirety.

### BACKGROUND

Field of the Disclosure

The present disclosure generally relates to the field of computer search optimization, and in particular relates to methods and apparatuses for information presentation based on a service object.

Description of Related Art

With the rapid development of network technologies, various network platforms integrate masses of product information, such that it is convenient for various web sites to communicate with other users via the network platform. There are generally two ways a back-end user allows more front-end users to acquire his or her product information. One approach is natural keyword searches, and the other approach is competitive keyword promotion. When using natural keyword searches, the competition is severe and the optimization cycle is long. Therefore, many back-end users select the second approach.

In keyword promotion, the back-end user needs to select a keyword and part of the search parameters in advance, and match the product information under the keyword. If a front-end user has searched for the keyword, the platform then performs a series of operations such as optimization, sorting, and the like, according to the search parameters, and then presents the corresponding product information. Accordingly, the setting of search parameters greatly impacts the presentation of product information.

Since the setting of search parameters imposes a higher requirement on the technical capability of the back-end user, for most users, operations such as optimization, sorting, and the like, by the network platform are relatively complicated, and the back-end user does not know how to set many of the search parameters. Therefore, the technical threshold is relatively high, and in particular, it is very costly for new users who lack experience and have poor technical capabilities.

Inappropriate search parameters tend to result in non-ideal search results. Under most circumstances, the user may repeatedly select the search parameters, and as a result, a client and a platform server repeatedly make responses to resetting of the selected search parameters. This increases time required of the user, and additionally greatly increases resource consumption of the client and the platform server.

### BRIEF SUMMARY

In view of the above technical problems, embodiments of the present disclosure provide methods and apparatus for information presentation based on a service object to overcome the above technical problems, or at least partially solve the above technical problems.

One aspect of the disclosure is drawn to a method for presenting information based on a service object. The method includes receiving an adjustment request for a search parameter with respect to a first service object from a client device, the adjustment request including a first parameter value, identifying one or more second parameter values, calculating one or more relationship parameters, wherein calculating one or more relationship parameters includes determining a relationship between the search parameter and one or more actual total presentation quantities of the first service object, calculating one or more estimated total presentation quantities using the first parameter value, the one or more second parameter values, and the one or more relationship parameters, fitting a relationship curve between the search parameter and the one or more estimated total presentation quantities based on the first parameter value, the one or more second parameter values, and the one or more estimated total presentation quantities, and the one or more estimated total presentation quantities, and transmitting the relationship curve to the client device.

In some embodiments of the disclosure, the method further collecting statistics relating to at least one presentation zone of the first service object in at least one presentation page based on log data, searching, by the server, for the first service object by using a search keyword, determining, by the server, one or more actual presentation quantities of the first service object, the one or more actual presentation quantities based on the collected statistics, accumulating, by the server, the one or more actual presentation quantities to determine one or more actual total presentation quantities of the first service object, and calculating, by the server, a relationship parameter between the search keyword and one or more actual total presentation quantities. In some embodiments of the disclosure, the method further comprises pre-processing the log data, wherein the pre-processing includes one or both of eliminating noise data and removing invalid data based on a geographic location.

In some embodiments of the disclosure, the method further comprises calculating one or more estimated presentation quantities based on the first parameter value and the one or more second parameter values, wherein each of the one or more estimated presentation quantities is calculated based on one or more relationship parameters associated with the one or more estimated presentation quantities and accumulating, by the server, the one or more estimated presentation quantities to determine the one or more estimated total presentation quantities.

In some embodiments of the disclosure, fitting the relationship curve further comprises fitting the relationship curve between the search parameter and the one or more estimated total presentation quantities using the first parameter value, the one or more second parameter values, and the one or more estimated total presentation quantities according to a linear relationship.

In some embodiments of the disclosure, fitting the relationship curve further comprises fitting a relationship curve between the search parameter and the one or more estimated total presentation quantities using a first slope within an adjacent zone of a first target parameter value, wherein the first target parameter value is a search parameter having a highest value when a second service object is presented and wherein the first slope is smaller than a predetermined first slope threshold. In some embodiments, fitting the relationship curve further comprises fitting a relationship curve between the search parameter and the one or more estimated total presentation quantities using a second slope within an adjacent zone of a second target parameter value, wherein the second target parameter value is a search parameter having a lowest value when a second service object is presented, and wherein second slope is greater than a predetermined second slope threshold.

In some embodiments of the disclosure, the method further comprising calculating a rank score of a searched for service object based on the search parameter, and selecting, by the server, one or more service objects having the highest rank scores.

In some embodiments of the disclosure, the search parameter includes a permission parameter, and wherein a rank score is calculated based on the product of the permission parameter, a pre-calculated quality parameter, and a pre-calculated estimated click through rate.

In some embodiments of the disclosure, the first parameter value and the one or more second parameter values used by the method are values of the search parameter, the first parameter value being different from the one or more second parameter values.

Another aspect of the disclosure is drawn to a method for presenting information based on a service object. The method includes receiving an adjustment request for a search parameter with respect to a first service object, the adjustment request including a first parameter value, searching for one or more relationship parameters corresponding to one or more keywords, a relationship parameter identifying a relationship between the search parameter and one or more actual total presentation quantities when the first service object was previously searched for using one of the one or more keywords and displayed, calculating one or more estimated total presentation quantities using the first parameter value, the one or more second parameter values, and the one or more relationship parameters, and transmitting, to the client, the first parameter value, the one or more second parameter values, and the one or more estimated total presentation quantities such that a relationship curve between the search parameter and the one or more estimated total presentation quantities is fitted and presented according to the first parameter value, the one or more second parameter values, and the one or more estimated total presentation quantities.

Another aspect of the disclosure is drawn to an apparatus for presenting information based on a service object. The apparatus includes a processor and a non-transitory memory storing computer-executable instructions therein that, when executed by the processor, cause the apparatus to receive an adjustment request for a search parameter with respect to a first service object from a client device, the adjustment request including a first parameter value, identify one or more second parameter values, calculate one or more relationship parameters, wherein calculating one or more relationship parameters includes determining a relationship between the search parameter and one or more actual total presentation quantities of the first service object, calculate one or more estimated total presentation quantities using the first parameter value, the one or more second parameter values, and the one or more relationship parameters, fit a relationship curve between the search parameter and the one or more estimated total presentation quantities based on the first parameter value, the one or more second parameter values, and the one or more estimated total presentation quantities, and transmit the relationship curve to the client device.

In some embodiments of the disclosure, the instruction to fit the relationship curve fitting further causes the apparatus to fit the relationship curve between the search parameter and the one or more estimated total presentation quantities using the first parameter value, the one or more second parameter values, and the one or more estimated total presentation quantities according to a linear relationship.

In some embodiments of the disclosure, the instruction to fit the relationship curve further causes the apparatus to fit the relationship curve between the search parameter and the one or more estimated total presentation quantities using a first slope within an adjacent zone of a first target parameter value, wherein the first target parameter value is a search parameter having a highest value when a second service object is presented, the second service object being a service object other than the first service object, and wherein the first slope is smaller than a predetermined first slope threshold.

In some embodiments of the disclosure, the instruction to fit the relationship curve causes the apparatus to fit the relationship curve between the search parameter and the one or more estimated total presentation quantities using a second slope within an adjacent zone of a second target parameter value, wherein the second target parameter value is a search parameter having a lowest value when a second service object is presented, the second service object being a service object other than the first service object, and wherein the second slope is greater than a predetermined second slope threshold.

Another aspect of the disclosure is drawn to an apparatus for presenting information based on a service object. The apparatus includes a processor and a non-transitory memory storing computer-executable instructions therein that, when executed by the processor, cause the apparatus to receive an adjustment request for a search parameter with respect to a first service object from a client device, the adjustment request comprising a first parameter value, search for one or more relationship parameters corresponding to one or more keywords, a relationship parameter identifying a relationship between the search parameter and one or more actual total presentation quantities when the first service object was previously searched for using one of the one or more keywords and displayed, calculate one or more estimated total presentation quantities using the first parameter value, the one or more second parameter values, and the one or more relationship parameters, and transmit the first parameter value, the one or more second parameter values, and the one or more estimated total presentation quantities to the client device, such that a relationship curve between the search parameter and the one or more estimated total presentation quantities is fitted and according to the first parameter value, the one or more second parameter values, and the one or more estimated total presentation quantities.

In some embodiments of the disclosure, the instructions further cause the apparatus to calculate a relationship parameter between the search parameter and the one or more actual total presentation quantities when the first service object is searched for using one of the one or more keywords and then displayed.

In some embodiments of the disclosure, the instruction to calculate the relationship parameter further causes the apparatus to collect statistics, relating to at least one presentation zone of the first service object in at least one presentation page based on log data, search for the first service object using a search keyword, determine one or more actual presentation quantities of the first service object, the one or more actual presentation quantities based on the collected statistics, accumulate the one or more actual presentation quantities to determine one or more actual total presentation quantities of the first service object, and calculate a relationship parameter between the search keyword and the one or more actual total presentation quantities.

In some embodiments of the disclosure, the instruction to calculate the relationship parameter further causes the apparatus to pre-process log data, wherein the pre-processing includes one or both of eliminating noise data and removing invalid data according to a geographic location.

In some embodiments of the disclosure, the instruction to calculate a plurality of estimated total presentation quantities further causes the apparatus to calculate one or more estimated presentation quantities based on the first parameter value and the one or more second parameter values, wherein each of the one or more estimated presentation quantities is calculated based on one or more relationship parameters associated with the one or more estimated presentation quantities, and accumulate the one or more estimated presentation quantities to determine the one or more estimated total presentation quantities.

The embodiments of the present disclosure have the following advantages. According to the embodiments of the present disclosure, estimated total presentation quantities values are estimated with different parameters based on a relationship parameter between a search parameter and an actual total presentation quantity when a first service object is presented as a result of a search keyword, and then a relationship curve between the search parameter and the estimated total presentation quantity is fitted, thereby giving an intuitive search effect to a user. This greatly lowers the required technical knowledge, and significantly improves convenience in setting the search parameter. As such, the user is capable of selecting an appropriate search parameter and acquiring an ideal search result, thereby preventing the user from repeatedly selecting the search parameter, reducing redundant responses to setting operations of a client and a platform server, reducing time consumption of the user, and additionally lowering resource consumption of the client and the platform server.

### BRIEF DESCRIPTION OF THE DRAWINGS

A more complete appreciation of the disclosed embodiments and many of the attendant advantages thereof will be more readily obtained by reference to the accompanying drawings when considered in connection with following detailed description.

FIG. 1 is a flow diagram illustrating a method for information presentation based on a service object according to some embodiments of the present disclosure.

FIG. 2 is a flow diagram illustrating a method according to some embodiments of the present disclosure.

FIG. 3 is a flow diagram illustrating a method according to some embodiments of the present disclosure.

FIG. 4 is a schematic flow diagram illustrating a method according to some embodiments of the present disclosure.

FIG. 5 is a diagram illustrating a relationship curve between a search parameter and an estimated total presentation quantity according to some embodiments of the present disclosure.

FIG. 6A and FIG. 6B are diagrams of a relationship between a bid price and traffic according to some embodiments of the present disclosure.

FIG. 7 is a flow diagram illustrating a method for information presentation based on a service object according to some embodiments of the present disclosure.

FIG. 8 is a schematic flow diagram illustrating a method according to some embodiments of the present disclosure.

FIG. 9 is a flow diagram illustrating a method according to some embodiments of the present disclosure.

FIG. 10 is a block diagram illustrating an apparatus for information presentation based on a service object according to some embodiments of the present disclosure.

FIG. 11 is a block diagram illustrating an element of an apparatus according to some embodiments of the present disclosure.

FIG. 12 is a block diagram illustrating an element of an apparatus according to some embodiments of the present disclosure.

FIG. 13 is a block diagram illustrating an element of an apparatus according to some embodiments of the present disclosure.

FIG. 14 is a block diagram illustrating an apparatus for information presentation based on a service object according to some embodiments of the present disclosure.

FIG. 15 is a block diagram illustrating an element of an apparatus according to some embodiments of the present disclosure.

FIG. 16 is a block diagram illustrating an element of an apparatus according to some embodiments of the present disclosure.

FIG. 17 is a block diagram illustrating an element of an apparatus according to some embodiments of the present disclosure.

### DETAILED DESCRIPTION

To make the objectives, features, and advantages of the present disclosure clearer and more understandable, the present disclosure is described in detail below with reference to the attached drawings and specific embodiments.

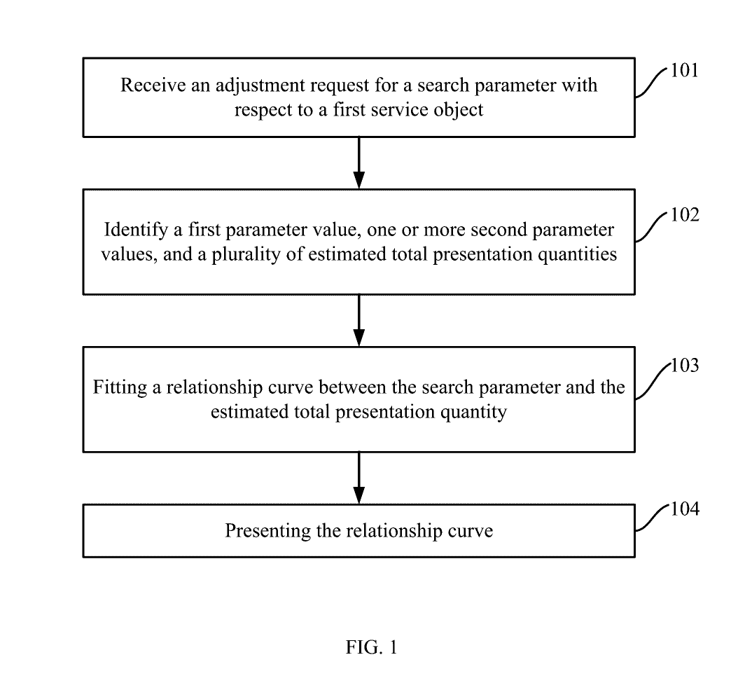

FIG. 1 is a flow diagram illustrating a method for presenting information based on a service object, according some embodiments of the present disclosure.

In some embodiments, the present disclosure may be applied to a network platform, which may be an independent server or server cluster (for example, a distributed system) storing service objects in different fields. In different fields, there may be different service objects (for example, a first service object and a second service object), that is, the data embodying the features of the field.

For example, in the field of communications, a service object may be communication data; in the field of news media, a service object may be news data; in the field of search engines, a service object may be a webpage; in the field of electronic commerce, a service object may be advertisement data, or the like. In different fields, although different service objects bear different field features, the service objects all include data, for example, text data, image data, audio data, video data, and the like. In the embodiments of the present disclosure, an exemplary description is given using advertisement data as a service object as an example; however, the disclosure is not limited to this field.

In step 101, the method receives an adjustment request for a search parameter with respect to a first service object.

In the embodiments of the present disclosure, a first service object pertains to a back-end user (identified by a user ID). Generally, the back-end user may log in to a management interface of a network platform via a client (for example, a browser) and send an adjustment request to request the network platform to adjust a search parameter of the first service object. The search parameter is used to calculate a rank score of a searched for service object, and one or more service objects whose rank scores are the highest are selected for presentation. In some embodiments, some of the search parameters are defined by the user, and some of the search parameters are set by the network platform.

In the embodiments of the present disclosure, the adjustment request may include a first parameter value. The first parameter value is the value of the search parameter, that is, the value of the search parameter equals the first parameter value, and is used to request the network platform to adjust the value of the search parameter to the first parameter value.

In some embodiments, the search parameter may comprise anchor text, that is, a segment of description about a link on a webpage, which may point to a location in the text or may point to another webpage, and is generally used for search engine optimization (SEO).

In some embodiments, the search parameter may comprise a permission parameter, wherein the permission parameter may be used to restrain the presentation operation of the service object. For example, with respect to advertisement data in the field of electronic commerce, the permission parameter may be a bid price defined by an advertiser for the advertisement data. In this example, the rank score is then a product obtained by multiplying the permission parameter by a pre-calculated quality parameter (which is used to measure a match degree between a search keyword and a service object), and by a pre-calculated estimated click through rate (which is the click through rate of the service object acquired based on model estimation, and is referred to as an “estimated CTR” or “eCTR”). That is, the rank score may be calculated by using the equation:

RankScore=BidPrice×QS×eCTR. (1)

In equation (1), RankScore denotes a rank score, eCTR denotes an estimated click through rate, and QS denotes a quality parameter.

Alternatively, in other embodiments of the present disclosure, the rank score may be calculated in a different manner, for example, using the equation

RankScore=eCTR^{α}×BidPrice,

where α denotes a parameter for correcting the eCTR. The manner of calculating the rank score is not limited to the above exemplary embodiments.

Each presentation is a presentation quantity or a page view (PV, website traffic) for a service object.

In step 102, the method identifies the first parameter value, one or more second parameter values, and a plurality of estimated total presentation quantities, wherein the plurality of estimated total presentation quantities are calculated using the first parameter value and the one or more second parameter values according to one or a plurality of relationship parameters.

Generally, a back-end user may bind the service object to search keywords. When the search keyword matches the search keyword searched for by a front-end user, the rank score is calculated using the search parameter, and one or more service objects whose rank scores are the highest are presented. However, due to the volume of search keywords, a high requirement is imposed on the search capabilities of the back-end user. For most users, the operations are complicated, and thus very costly. In the above manner, the utilization rate of high-volume traffic, especially long-tail traffic (the search traffic caused by non-selected search keywords), is not high.

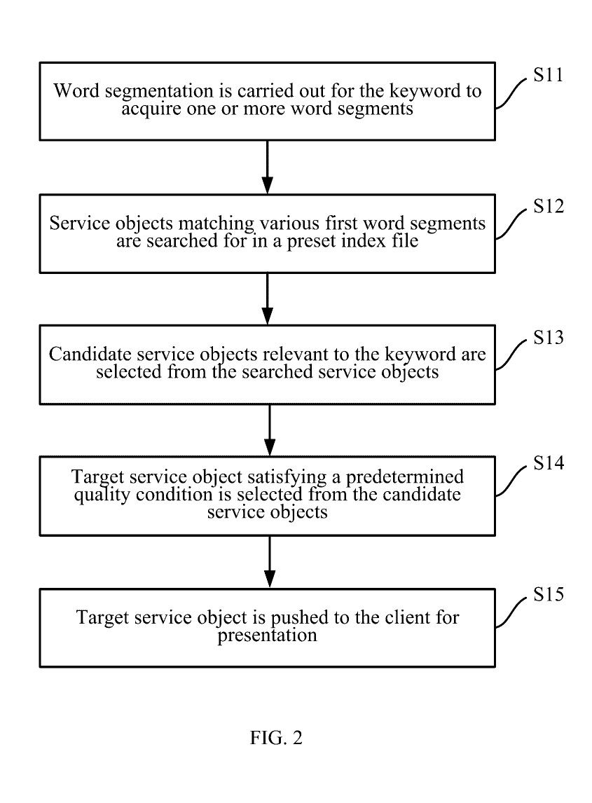

Therefore, in some embodiments of the present disclosure, the service objects may be presented in the following whole text search manner (as illustrated in FIG. 2).

In step S11, when a search keyword is received, word segmentation is carried out on the keyword to acquire one or more word segments.

In step S12, the method searches for service objects matching various first word segments in a preset index file. Additionally, the method may search for second word segments matching the various first word segments in the preset index file. In one embodiment, second word segments are word segments acquired by carrying out word segmentation for the text information in the service objects. Then, the service objects mapped to the second word segments are searched.

In step S13, the method selects candidate service objects relevant to the keyword from the searched service objects. Some of the service objects matching the first word segments may be intercepted, and an overlap of the intercepted service objects may be filtered to acquire the candidate service objects. Alternatively, one or more first categories of the search keyword and a second category of the candidate service objects may be searched. A correlation between the one or more first categories and the second category may also be searched. One or more of the candidate service objects having a highest correlation may be selected.

In step S14, the method selects a target service object satisfying a predetermined quality condition from the candidate service objects. Further, a correlation between the candidate service objects and the search keyword and an estimated click through rate may be acquired. A rank score may be calculated according to the correlation and the estimated click through rate. A candidate service object whose rank score satisfies the predetermined quality condition is selected as the target service object.

In step S15, the method sends the target service object to the client for presentation. In one embodiment, the user may load a page (for example, a page on an electronic commerce website, a page of a search engine, or the like) by using a client (for example, a browser or the like), and input a search keyword (query) in the page. If the user clicks a control such as “OK”, “Search”, or the like, the client may send a search request to the network platform based on the search keyword (i.e., a query).

In one embodiment, if the network platform receives a search keyword submitted by the client, products, webpages, and the like, relevant to the search keyword may be searched (that is, natural search). In other embodiments, the service objects bound to the search keyword may be searched (that is, competition promotion).

Each time when searching, a search parameter may be used. In the embodiments of the present disclosure, a relationship parameter may be used to describe a relationship between the search parameter and an actual total presentation quantity. The relationship parameter is a relationship between the search parameter and an actual total presentation quantity when the first service object was previously searched for using a search keyword and then displayed (that is, the search keywords cause traffic to the back-end user). The actual total presentation quantity may be the total number of times that service objects are actually presented within a period of time (for example, one day, one week, or the like).

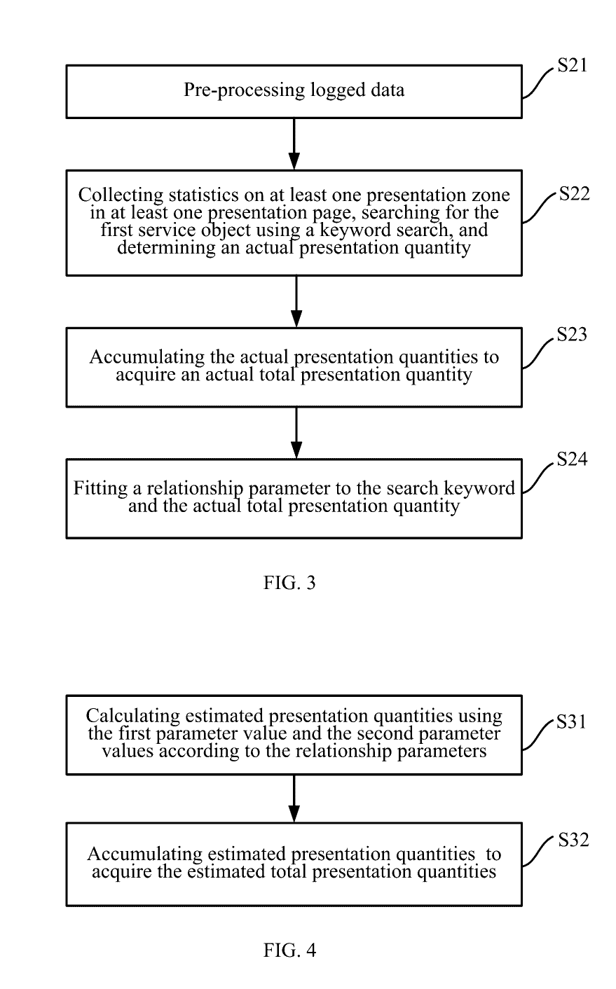

In some embodiments of the present disclosure, the server may calculate the relationship parameter using the following substeps illustrated in FIG. 3.

In step S21, the method pre-processes log data. The network platform is generally presented to the user in the form of a website, and the front-end user performs corresponding operations on the website. The log data of the website records behavioral information of the front-end user, for example, search, browse, click, add to favorites, and the like. It also records information of the service object, for example, presentation, click, price offer, fee deduction, and the like of advertisement data.

An example of the log data format of an electronic commerce website is as listed in the following table.

| Serial | | |
|---|---|---|
| Number | Name | Description |
| 1 | Query | Search keyword |
| 2 | Offer_ID | ID identifying an offer (advertisement data) |
| 3 | Company_ID | ID of the user (company) providing the offer |
| | | (advertisement data) |
| 5 | Rank | Rank of the offer |
| 6 | Is_Click | Whether the offer is clicked |
| . . . | . . . | . . . |

Before use of the log data, the log data may be pre-processed to clear irrelevant or invalid data, so as to improve the accuracy of the log data.

The pre-processing may comprise one or both of the following.

1. Eliminating Noise Data

In practical application, fraudulent data, crawler data, and the like, may be considered noise data, and clearing of noise data from the data means clearing the fraudulent data, the crawler data, and the like. The fraud is diversified. For example, in the field of electronic commerce, in order to present his or her own advertisement data, a back-end user may constantly click advertisement data, bound to the same search keyword, of other competitor back-end users in an unscrupulous manner, such that the budget of the competitor is exhausted, and then his or her own advertisement data is presented. Crawler data is the information acquired from other websites using a crawler tool, desiring to acquire information on a website. The log data acquired by such crawlers may be filtered.

2. Clearing Invalid Data According to a Geographic Location

Invalid clicks may refer to the case where a website mainly provides information for users in a specific zone. The location where a user initiates an operation may be detected via the IP address, and if the location is out of the zone, then the generated log data may be considered invalid data. For example, if the website mainly provides information for users abroad, the operations of domestic users may be filtered.

The pre-processing discussed above is only exemplary. In alternative embodiments, other pre-processing steps may be executed according to the actual needs, and preprocessing is not limited to the embodiments described in the present disclosure. A person skilled in the art may employ other pre-processing manners according to the actual needs.

In step S22, the method collects statistics on at least one presentation zone of the first service object in at least one presentation page according to log data, searches for the first service object using a keyword search, and determines an acquired actual presentation quantity.

In step S23, the method accumulates the actual presentation quantities to acquire an actual total presentation quantity as discussed in more detail below. In different scenarios there are generally different presentation pages selected for presentation. For example, the home page of an electronic commerce web site, a commodity promotion page of the electronic commerce website, a search result page of a search engine, or the like. One or more presentation zones (Pid) are set on each of the presentation pages. Generally, a service object having a higher rank score has a better presentation zone, for example, a relatively higher or prominent position of the presentation zone.

Actual presentation quantities of all the presentation zones are statistically collected in the log data, and through accumulation of the actual presentation quantities an actual total presentation quantity of a search keyword may be acquired.

In step S24, the method fits a relationship parameter to the search keyword and the actual total presentation quantity. With respect to a search keyword, a relationship parameter may be fitted, and an exemplary description is given with reference to fitting a relationship parameter to a keyword and an actual total presentation quantity by using advertisement data in the field of electronic commerce.

Generally, a rank score is calculated by using equation (1) above, that is, RankScore=BidPrice×QS×eCTR. A higher RankScore denotes a top or more prominent location for the advertisement data, and thus the advertisement data may be better presented. In this way, a higher actual total presentation quantity PV is acquired.

Therefore, an estimated total presentation quantity PV with a permission parameter BidPrice may be acquired as an aspect of a keyword search by ranking the rank score, RankScore.

With respect to the presentation zones Pid on all the presentation pages, the actual presentation quantity PV may be statistically collected. Assume that an advertiser company 1 has advertisement data P₁, and the corresponding estimated click through rate eCTR is eCTR₁. It is acquired through statistical collection from the log data that two search keywords k₁ and k₂ cause the actual presentation quantity PV for the advertisement data P₁. Quality parameters QS of the search parameter and the advertisement data P₁ are respectively a quality parameter QS₁ and a quality parameter QS₂.

Assume that the presentation zone Pid of the website includes presentation zones Pid₁ and Pid₂. For the search keywords k₁ with a permission parameter BidPrice₁, the actual presentation quantity PV acquired in the presentation zone Pid₁ is PV₁₁, and the actual presentation quantity PV acquired in the presentation zone Pid₂ is PV₁₂. That is, the actual presentation quantities PV₁₁ and PV₁₂ are represented by the following equations.

PV₁₁=ƒ(BidPrice₁,QS₁,eCTR₁) (2)

PV₁₂=ƒ(BidPrice₁,QS₁,eCTR₁) (3)

For the search keywords k₂ with a permission parameter BidPrice₁, the actual presentation quantity PV acquired in the presentation zone Pid₁ is PV₂₁, and the actual presentation quantity PV acquired in the presentation zone Pid₂ is PV₂₂. That is, the actual presentation quantities PV₂₁ and PV₂₂ are represented by the following equations:

PV₂₁=ƒ(BidPrice₁,QS₂,eCTR₁) (4)

PV₂₂=ƒ(BidPrice₁,QS₂,eCTR₁) (5)

In the above equations, ƒ(•) denotes a functional relationship between the actual presentation quantity and the permission parameter BidPrice, the quality parameter QS, and the estimated click through rate eCTR. That is, the actual presentation quantity PV is determined by three factors including the permission parameter BidPrice, the quality parameter QS, and the estimated click through rate eCTR.

According to the derivations and equations (2) through (5) above, a relation between an actual total presentation quantity PV, caused by each search keyword to the product, and the permission parameter BidPrice is acquired as follows:

PV=ƒ(BidPrice,QS,eCTR) (6)

With respect to the same service object, in a case where the information is not changed, the quality parameter QS and the estimated click through rate eCTR would generally not be subject to change. Therefore, it may be assumed that the quality parameter QS and the estimated click through rate eCTR are constants.

Therefore, the following equation may be derived from the equation (6) above.

PV=ƒ(BidPrice) (7)

The actual total presentation quantity PV may be statistically collected in the log data and, according to the permission parameter BidPrice, the function ƒ(•) may be calculated, that is, the relationship parameter may be acquired.

Nevertheless, some advertisement data may have different permission parameters (BidPrice). In this case, an average value of the permission parameters BidPrice within a period of time (for example, within seven days) may be calculated to fit the relationship parameter.

In addition, to mitigate the impacts caused by fluctuation of the relationship parameter, an average value of a plurality of relationship parameters may be calculated as the final relationship parameter. For example, a relationship parameter within one day may be fitted with respect to a search keyword, and then an average value of the relationship parameters within seven days is taken as the final relationship parameter.

It should be noted that, the relationship parameter may be calculated offline by a platform server, or may be calculated online by the platform server, and is not limited to the embodiments of the present disclosure. During calculation of the relationship parameter, the relationship parameter may be directly fitted, or may be acquired by training a model by means of a decision tree, a support vector machine (SVM), or the like, and is not limited to the embodiments of the present disclosure either.

Further, the server may calculate a plurality of estimated total presentation quantities by using the first parameter value and the one or more second parameter values according to the one or more relationship parameters, respectively. The one or more second parameter values are values of the search parameter. Specifically, the second parameter value may be acquired based on the first parameter value, that is, the first parameter value is different from the one or more second parameter values.

For example, to guide the back-end user to increase the value of the permission parameter to acquire a higher presentation quantity PV, the relationship curve may be fitted by using the second parameter value, which is greater than the first parameter value.

In some embodiments of the present disclosure, the server may calculate the plurality of estimated total presentation quantities as illustrated in FIG. 4.

In step S31, the method calculates a plurality of estimated presentation quantities using the first parameter value and the one or more second parameter values according to the relationship parameters.

In step S32, the method accumulates the plurality of estimated presentation quantities with respect to the first parameter value and the one or more second parameter values to acquire the plurality of estimated total presentation quantities.

According to the equation (7) above, the relationship parameter ƒ(•) of a search keyword is known and the value of the permission parameter BidPrice is the known first parameter value or second parameter value. In this case, an estimated presentation quantity PV caused by the search keyword may be determined. The estimated presentation quantities PV caused by all the search keywords are accumulated to acquire an estimated total presentation quantity PV that may be acquired by a back-end user. If the estimated total presentation quantity PV is acquired through calculation, then the estimated total presentation quantity PV and the corresponding second parameter value may be returned to the client for simulation of the relationship curve.

In step 103 of FIG. 3, a relationship curve between the search parameter and the estimated total presentation quantity is fitted according to the first parameter value, the one or more second parameter values, and the plurality of estimated total presentation quantities. In some embodiments, the relationship curve between the search parameter and the estimated total presentation quantity may be fitted by using the first parameter value, the one or a plurality of second parameter values, and the plurality of estimated total presentation quantities according to a linear relationship.

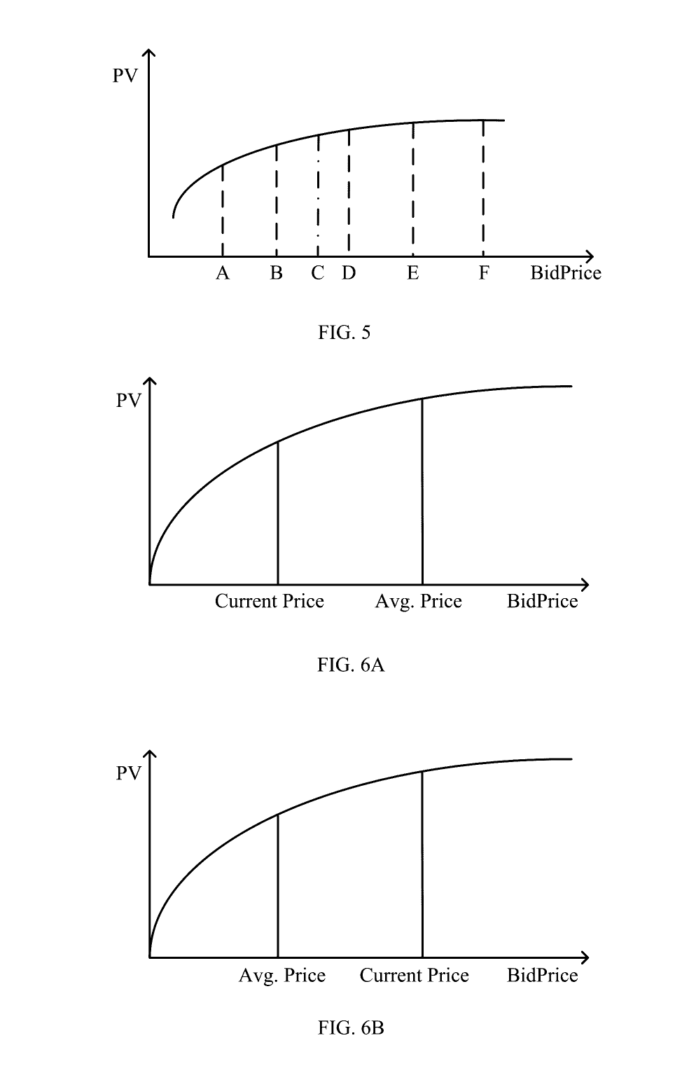

For example, as illustrated in FIG. 5, the relationship curve between the search parameter and the estimated total presentation quantity may be fitted by using the values of a plurality of permission parameters (BidPrice), that is, the first parameter value A, and the second parameter values B, C, D, E, and F, and a one-to-one corresponding estimated total presentation quantity PV. In addition to fitting of the relationship curve between the search parameter and the estimated total presentation quantity according to a linear relationship, the relationship curve may also be fitted according to a non-linear relationship, for example, by acquiring a high order curve by means of spline fitting. The particular fitting used is not limited in the present disclosure.

In some embodiments, step 103 may include fitting a relationship curve between the search parameter and the estimated total presentation quantity using a first slope within an adjacent zone of a first target parameter value. The first target parameter value may be a search parameter having a highest value when a second service object is presented, where the second service object is a service object other than the first service object.

In an embodiment using advertisement data in electronic commerce, for example, the second service object may be advertisement data of other back-end users. The adjacent zone of the first target parameter value may be a range acquired by adding and/or subtracting a specific distance from the first target parameter value.

The first slope may be smaller than a predetermined first slope threshold, indicating that the first slope is relatively small. As illustrated in FIG. 5, assume that point F is a first target parameter. Then in the relationship curve, within a zone adjacent to the point F, for an increase of the value of the permission parameter BidPrice, the increase of the estimated total presentation quantity PV is not significant, and is close to zero. In this case, the relationship curve tends to be horizontal. For example, in the field of electronic commerce, the first target parameter value may be a highest bid price in history. For a bid price higher than the first target parameter value, it is determined that the advertisement data can be presented, and the estimated total presentation quantity PV will not increase.

In some embodiments of the present disclosure, step 103 may include fitting a relationship curve between the search parameter and the estimated total presentation quantity using a second slope within an adjacent zone of a second target parameter value. The second target parameter value may be a search parameter having a lowest value when a second service object is presented, where the second service object is a service object other than the first service object. When there are a plurality of presented second service objects, the second parameter value may be further represented as an average value of a plurality of second target parameter values having the lowest value when the second service object is presented multiple times, and the adjacent zone of the second target parameter value may be a range acquired by adding and/or subtracting a specific distance from the second target parameter value.

The second slope may be greater than a predetermined second slope threshold, indicating that the second slope is great. As illustrated in FIG. 5, assume that point B is the second target parameter value. Then in the relationship curve, within a zone adjacent to the point B, for an increase of the value of the permission parameter BidPrice, the increase of the estimated total presentation quantity PV is significant. In this case, the relationship curve tends to be steep. For example, in the field of electronic commerce, the second target parameter value may be a lowest bid price in history (or a lowest average bid price) when the advertisement data is presented. For a bid price lower than the second target parameter value, it is generally difficult for the advertisement data to be presented, and the estimated total presentation quantity PV is very low. For a bid price higher than the second target parameter value, the probability that the advertisement data is presented greatly increases and the estimated total presentation quantity PV is significantly improved.

The above fitting methods are only exemplary. In practicing the embodiments of the present disclosure, other fitting methods may be defined according to the actual needs. For example, the relationship curve can be fitted by using an estimated total presentation quantity PV corresponding to an average value C of the search parameter as illustrated in FIG. 5, or the like. The fitting method is not limited to the embodiments of the present disclosure. In addition, to the above fitting manner, a person skilled in the art may employ other fitting manners according to the actual need.

In step 105, the method transmits the relationship curve to the client. The client presents, or displays, the relationship curve to the user, and the user may determine, according to the total search quantity, whether the current first parameter value is appropriate.

It should be noted that, the above fitting of the relationship curve based on the permission parameter is only an example. Other search parameters may also be used, for example, the quality parameter QS, the rank RankScore, or the like, to fit the relationship curve, and the particular parameter is not limited to the embodiments of the present disclosure.

According to the above embodiments of the present disclosure, estimated total presentation quantities are estimated with different parameter values based on a relationship parameter between a search parameter and an actual total presentation quantity when a first service object is presented in a result of a keyword search. Then, a relationship curve between the search parameter and the estimated total presentation quantity is fitted, thereby giving an intuitive search effect to a user. It greatly lowers the required technical threshold, and significantly improves convenience in setting the search parameter. As such, the user is capable of selecting an appropriate search parameter and acquiring an ideal search result. This avoids the user having to repeatedly select the search parameter, reduces redundant responses and setting operations of a client and a platform server, reduces time consumption of the user, and additionally lowers resource consumption of the client and the platform server.

Electronic commerce is a new industry which has gained dramatic development in recent years. To bring more product promotion opportunities to the seller, the electronic commerce websites generally provide more product presentation opportunities for the sellers in the form of advertisement data. On one hand, advertisers desire to pay less for the advertisement data, but also want to acquire more chances for presentation, so as to improve the return on investment (ROI). On the other hand, the electronic websites desire to make full use of the resources, and to earn more commission on the premise of ensuring the ROI of the advertisers.

Most electronic commerce websites provide one mode, that is, the advertisers acquire a chance for product presentation in a price bidding and ranking manner. To be specific, the websites acquire a ranking of the advertisement data of the advertisers according to the advertisement data <Query, Offer> (that is, the advertisement data Offer bound to the search keyword Query) acquired by model-based estimation. The model-based estimation is based on the search keywords bought by the advertiser, bid prices, and estimated click through rates (eCTRs) of the products. Finally, the websites determine the advertisement to be presented according to the ranking of the advertisement data.

An advertisement ranking algorithm currently prevailing in the industry is RankScore=BidPrice×QS×eCTR. For the electronic commerce websites, optimizing the eCTR may improve the click through rate of the presented advertisement data, and may result in more revenue. However, for the advertisers, while optimizing the product information and improving the product eCTR, a reasonable BidPrice needs to be defined to obtain more presentation chances, thereby achieving the objective of presenting their products. For a product with the same eCTR, the traffic obtained at different BidPrices is likely to be very different. However, price bidding and ranking in the above manner generally fails to achieve a good effect.

In one aspect, the advertisers would generally buy popular search keywords, and as a result, such popular search keywords are subject to severe competition. For such popular search keywords, low BidPrices fail to play any role, and create no promotion effect.

In another aspect, for the advertisers who are using the above scheme for the first time or do not have sufficient time to operate the advertisement, product promotion is complicated and can be subject to some difficulties. While the advertiser is overcoming the difficulties, no good promotion effect is created.

In addition, there is no ideal reference for defining a reasonable BidPrice for each search keyword. Therefore, to solve such problems, a faster and more convenient promotion method is defined.

For example, an electronic commerce website provides a fast promotion function. In fast promotion, the advertisers do not need to buy the search keywords or offer bid prices for the search keywords, but instead promote the products in the form of whole text search or virtual binding. Correspondingly, the advertisers only need to define a uniform bid price upper limit.

With respect to the keyword searched by the user, if a keyword bound to the main product involved in the advertisement is searched for, then the product participates in the ranking of biding prices in this search, and is exposed at the same position at a lowest bidding price.

However, in the fast promotion function, an average price is simply provided with respect to each of the current search keywords, but there is no reasonable function to guide the sellers to define the BidPrice according to the need (the needs of the traffic). With respect to the search keywords which are subjected to severe competition, each time much less advertisement data is exposed. However, there are a large number of search keywords participating in the ranking of the price biding. A better promotion effect fails to be achieved, even based on the average price, and demand-based pricing may not be achieved.

In addition, at present there is no tool capable of defining the bid price according to the requirements of the advertiser on the traffic. As a result, the advertisers may not intuitively sense the impacts caused by the bid pricing on the traffic. Therefore, the advertisers generally compete for the traffic by using a conservative BidPrice, which, however, fails to improve the traffic.

Assume that the advertisers currently define the BidPrice as a, and an average price of the bought search keywords is x.

When the BidPrice (Current Price) currently defined by the advertisers is lower than an average price (Avg. Price) on the market (i.e., when a<x), as illustrated in FIG. 6A, the advertisers, without any guidance, would not define a higher BidPrice, and generally use the average price on the market as a reference for pricing. As illustrated in FIG. 6A, within the pricing margin lower than the average price on the market, the PV still has a great improvement margin. No reasonable guidance is provided for the advertisers. As a result, many advertisers would not define a higher BidPrice to improve the PV.

When the BidPrice (Current Price) currently defined by the advertisers is higher than the average price (Avg. Price) on the market (i.e., when a>x), as illustrated in FIG. 6B, since the advertisers has no reference to define the BidPrice, the advertisers' enthusiasm in price bidding may not be spurred. It can be seen from the FIG. 6B, there is much space for the advertisers to improve PV in the curves greater than the current BidPrice. Since there is no good guidance, the advertisers cannot get greater promotion of the PV.

In conclusion, if the traffic at different BidPrices can be estimated for the advertisers and a relationship diagram between the BidPrice and the PV as illustrated in FIGS. 6A and 6B can be provided for the sellers, then the advertisers are capable of reasonably defining the BidPrice based on the guidance of the relationship diagram, and thus capable of improving the PV. In view of the above problem, it is a practical and feasible solution to provide a function which is capable of guiding the sellers to offer a reasonable price and improving the product traffic.

Therefore, a pay for performance (P4P) pricing traffic estimation method based on a keyword dimension is provided in the embodiments of the present disclosure, in which the traffic in different price biddings is estimated by using each search keyword purchased by the advertisers, thereby estimating the traffic PV that can be obtained at different BidPrices. The advertisers may be guided to define an appropriate BidPrice according to the requirements on the traffic PV by means of traffic estimation, thereby providing capability of getting traffic PV under different BidPrices to the advertisers, guiding the advertisers to define the BidPrice, promoting the traffic, and improving the promotion effect, thereby promoting the advertiser's return on investment. When the advertisers define the BidPrice and provide the return on investment, electronic commerce websites may get good profits under higher BidPrices, thereby achieving a win-win effect between the electronic commerce websites and the advertisers.

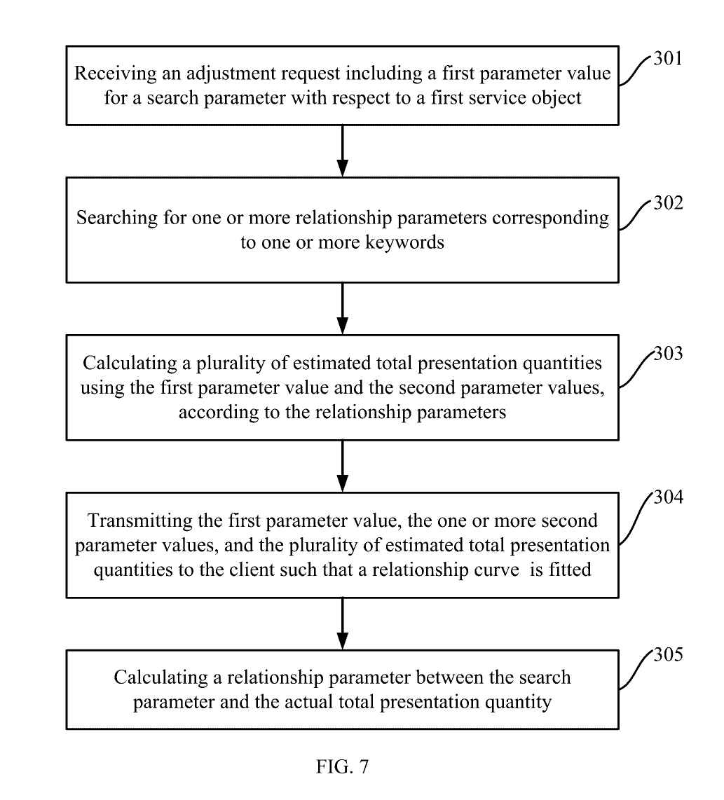

FIG. 7 is a flow diagram illustrating a method for presenting information based on a service object according to some embodiments of the present disclosure. The method includes the following steps 301 to 304, and may optionally include step 305.

In step 301, the method receives, from a client, an adjustment request for a search parameter with respect to a first service object. The adjustment request includes a first parameter value.

In step 302, the method searches for one or more relationship parameters corresponding to one or more keywords, the relationship parameter being a relationship between the search parameter and an actual total presentation quantity when the first service object was previously searched for using a search keyword and then displayed.

In step 303, the method calculates a plurality of estimated total presentation quantities by using the first parameter value and the one or more second parameter values, according to the one or more relationship parameters.

In step 304, the method transmits the first parameter value, the one or more second parameter values, and the plurality of estimated total presentation quantities to the client such that a relationship curve between the search parameter and the estimated total presentation quantity is fitted. The relationship curve is then presented on the client according to the first parameter value, the one or a plurality of second parameter values, and the plurality of estimated total presentation quantities.

In some embodiments of the present disclosure, the method may optionally further include step 305. In step 305, the method calculates a relationship parameter between the search parameter and the actual total presentation quantity when the first service object is searched using a search keyword and then displayed.

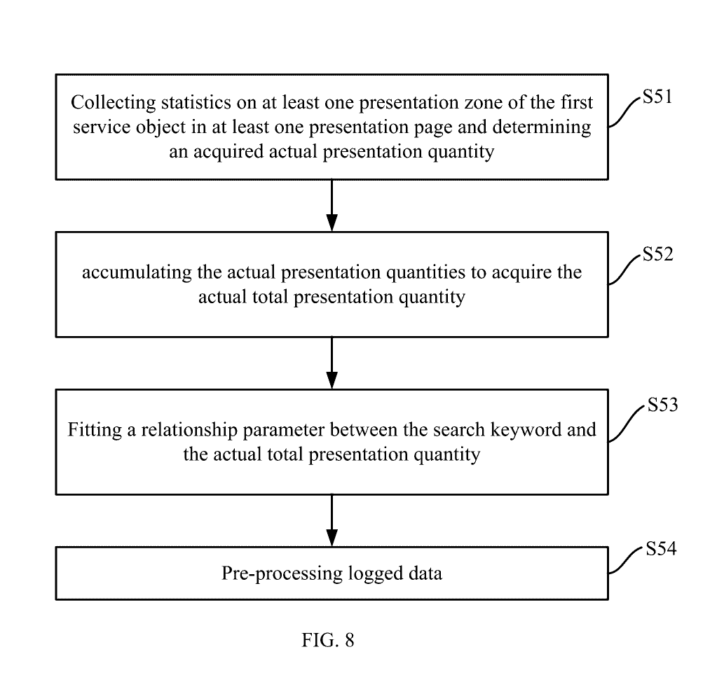

In some embodiments of the present disclosure, step 305 may include the following steps S51 to S53, and optionally may further include step S54 illustrated in FIG. 8.

In step S51, the method collects statistics on at least one presentation zone of the first service object in at least one presentation page according to log data, and searching for the first service object by using a search keyword and determining an acquired actual presentation quantity.

In step S52, the method accumulates the actual presentation quantities to acquire the actual total presentation quantity.

In step S53, the method fits a relationship parameter between the search keyword and the actual total presentation quantity.

In some embodiments of the present disclosure, step 305 may optionally further include step S54. In step S54, the method pre-processes the log data, where the pre-processing comprises one or both of eliminating noise data and clearing invalid data according to a geographic location.

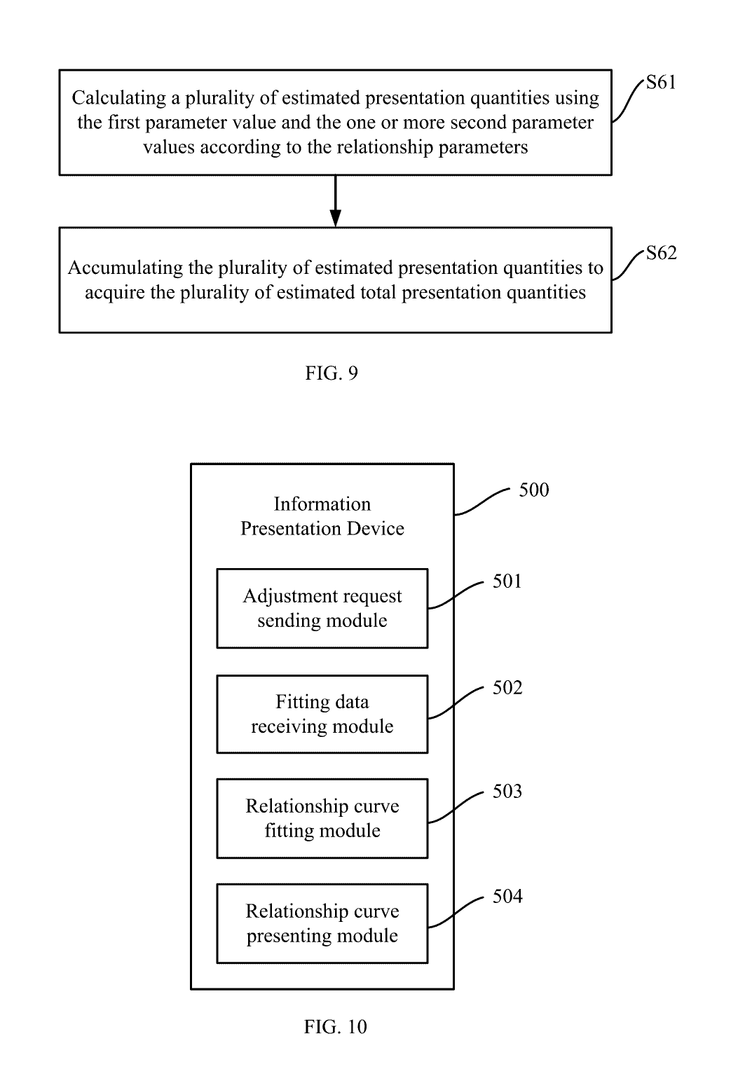

In some embodiments of the present disclosure, step 303 may include the following steps S61 and S62 illustrated in FIG. 9.

In step S61, the method calculates a plurality of estimated presentation quantities using the first parameter value and the one or more second parameter values according to the relationship parameters.

In step S62, the method accumulates the plurality of estimated presentation quantities with respect to the first parameter value and the one or more second parameter values to acquire the plurality of estimated total presentation quantities.

In some embodiments of the present disclosure, the client may fit the relationship curve by fitting the relationship curve between the search parameter and the estimated total presentation quantity by using the first parameter value, the one or a plurality of second parameter values and the plurality of estimated total presentation quantities according to a linear relationship.

In some embodiments of the present disclosure, the client may fit the relationship curve by fitting a relationship curve between the search parameter and the estimated total presentation quantity in a first slope within an adjacent zone of a first target parameter value. The first target parameter value is a search parameter having a highest value when a second service object is presented, the second service object being a service object other than the first service object, and the first slope is smaller than a predetermined first slope threshold.

In some embodiments of the present disclosure, the client may fit the relationship curve by fitting a relationship curve between the search parameter and the estimated total presentation quantity in a second slope within an adjacent zone of a second target parameter value. The second target parameter value is a search parameter having a lowest value when a second service object is presented, the second service object being a service object other than the first service object, and the second slope is greater than a predetermined second slope threshold.

In some embodiments, the search parameter may be used to calculate a rank score of a searched service object, one or more service objects having a highest rank score being used for presentation.

In some embodiments, the search parameter may include a permission parameter. A product of the permission parameter, a pre-calculated quality parameter, and a pre-calculated estimated click through rate determines a rank score.

In some embodiments, the first parameter value and the one or more second parameter values are values of the search parameter, and the first parameter value is different from the one or more second parameter values.

In the above embodiments of the present disclosure, since the methods have a similar application, a brief description is given for some elements in the embodiments corresponding to FIG. 7. The related elements may be referenced to the equivalent descriptions in the method corresponding to FIG. 1, and are thus not further described here.

It should be noted that, with respect to the method embodiments, for brevity of description, they are all described as a series of action combinations. However, a person skilled in the art shall understand that the embodiments of the present disclosure are not subjected to limitations of the action only in the sequences described above. Further, based on the embodiments of the present disclosure, some steps may be performed in another or other sequences or may be simultaneously performed. In addition, a person skilled in the art should also know that the embodiments described in the description herein are preferred embodiments, and all the involved actions are not required actions of the embodiments.

FIG. 10 is a block diagram illustrating an apparatus for information presentation based on a service object according to some embodiments of the present disclosure. The apparatus 500 includes an adjustment request sending module 501, a fitting data receiving module 502, a relationship curve fitting module 503, and a relationship curve presenting module.

An adjustment request sending module 501 is configured to send an adjustment request for a search parameter with respect to a first service object to a server, the adjustment request comprising a first parameter value.

A fitting data receiving module 502 is configured to receive, from the server, the first parameter value, one or a plurality of second parameter values and a plurality of estimated total presentation quantities calculated using the first parameter value and the one or a plurality of second parameter values according to one or a plurality of relationship parameters, the relationship parameter being a relationship between the search parameter and an actual total presentation quantity when the first service object was previously searched for using a search keyword and then displayed.

A relationship curve fitting module 503 is configured to fit a relationship curve between the search parameter and the estimated total presentation quantity according to the first parameter value, the one or a plurality of second parameter values and the plurality of estimated total presentation quantities.

A relationship curve presenting module 504 is configured to present the relationship curve.

In some embodiments of the present disclosure, the server may calculate the relationship parameter by invoking the following included submodules.

An actual presentation quantity statistical collecting submodule is configured to statistically collect at least one presentation zone of the first service object in at least one presentation page according to log data. The actual presentation quantity statistical collecting submodule is also configured to search for the first service object by using a search keyword and presenting an acquired actual presentation quantity.

An actual presentation quantity accumulating submodule is configured to accumulate the actual presentation quantities to acquire the actual total presentation quantity.

A relationship parameter fitting submodule is configured to fit a relationship parameter between the search keyword and the actual total presentation quantity.

In some embodiments of the present disclosure, the server may calculate the relationship parameter by invoking a pre-processing submodule configured to pre-process log data, where the pre-processing comprises one or both of eliminating noise data and clearing invalid data according to a geographic location.

In some embodiments of the present disclosure, the server may calculate the total presentation quantity by invoking the following included submodules.

An estimated presentation quantity calculating submodule is configured to calculate a plurality of estimated presentation quantities by using the first parameter value and the one or more second parameter values according to each relationship parameter.

An estimated presentation quantity accumulating submodule is configured to accumulate the plurality of estimated presentation quantities with respect to the first parameter value and the one or more second parameter values to acquire the plurality of estimated total presentation quantities.

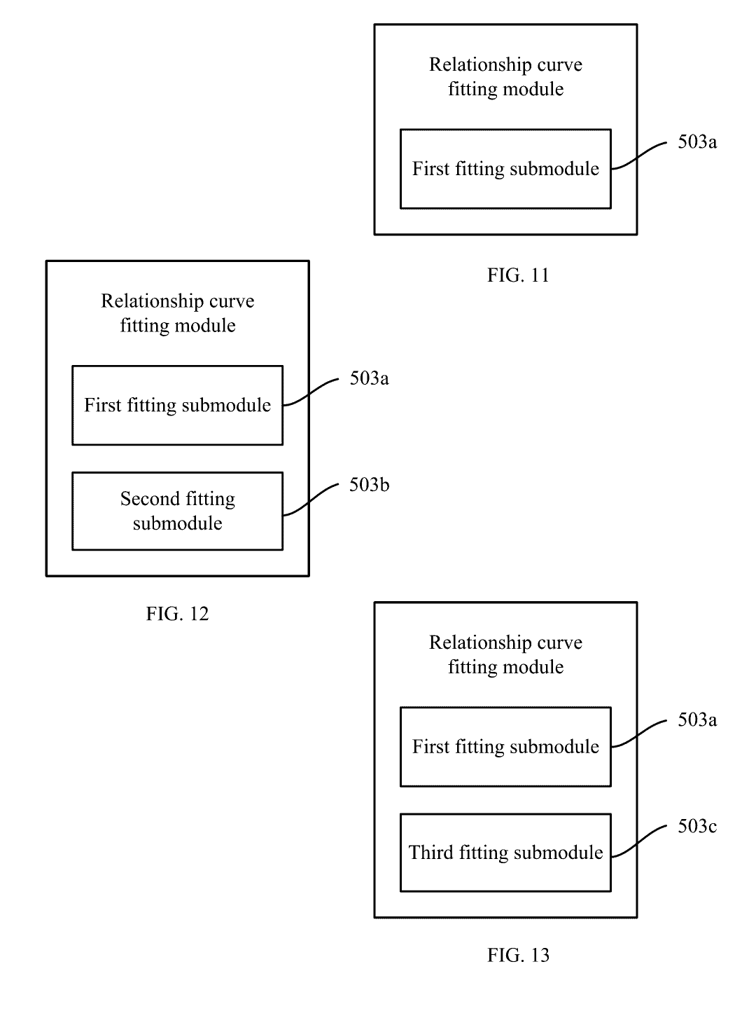

In some embodiments of the present disclosure, the relationship curve fitting module 503 may include a first fitting submodule 503a as illustrated in FIG. 11. The first fitting submodule 503a is configured to fit the relationship curve between the search parameter and the estimated total presentation quantity using the first parameter value, the one or more second parameter values, and the plurality of estimated total presentation quantities according to a linear relationship.

In some embodiments of the present disclosure, the relationship curve fitting module 503 may further include a second fitting submodule 503b, as illustrated in FIG. 12. The second fitting submodule 503b is configured to fit a relationship curve between the search parameter and the estimated total presentation quantity using a first slope within an adjacent zone of a first target parameter value. The first target parameter value is a search parameter having a highest value when a second service object is presented, the second service object being a service object other than the first service object, and the first slope is smaller than a predetermined first slope threshold.

In some embodiments of the present disclosure, the relationship curve fitting module 503 may further include a third fitting submodule 503c, as illustrated in FIG. 13. The third fitting submodule 503c is configured to fit a relationship curve between the search parameter and the estimated total presentation quantity using a second slope within an adjacent zone of a second target parameter value. The second target parameter value is a search parameter having a lowest value when a second service object is presented, the second service object being a service object other than the first service object, and the second slope is greater than a predetermined second slope threshold.

In some embodiments, the search parameter may be used to calculate a rank score of a searched service object, and one or more service objects having a highest rank score are selected for presentation.

In some embodiments, the search parameter may include a permission parameter, and a product of the permission parameter, a pre-calculated quality parameter, and a pre-calculated estimated click through rate is a rank score.

In some embodiments, the first parameter value and the one or more second parameter values are values of the search parameter, and the first parameter value is different from the one or more second parameter values.

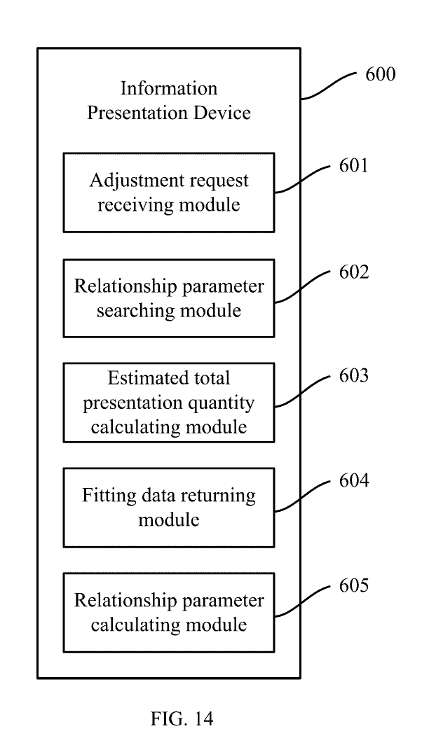

FIG. 14 is a block diagram illustrating an apparatus for information presentation based on a service object according to some embodiments of the present disclosure. The apparatus 600 includes an adjustment request receiving module 601, a relationship parameter searching module 602, an estimated total presentation quantity calculating module 603, and a fitting data returning module 604, and a relationship parameter calculating module 6.

An adjustment request receiving module 601 is configured to receive, from a client, an adjustment request for a search parameter with respect to a first service object, the adjustment request comprising a first parameter value.

A relationship parameter searching module 602 is configured to search for one or more relationship parameters corresponding to one or more keywords. A relationship parameter is a relationship between the search parameter and an actual total presentation quantity when the first service object was previously searched for using a search keyword and then displayed.

An estimated total presentation quantity calculating module 603 is configured to calculate a plurality of estimated total presentation quantities using the first parameter value and the one or more second parameter values according to the one or more relationship parameters.

A fitting data returning module 604 is configured to return the first parameter value, the one or more second parameter values, and the plurality of estimated total presentation quantities to the client such that a relationship curve between the search parameter and the estimated total presentation quantity is fitted and then displayed on the client according to the first parameter value, the one or more second parameter values, and the plurality of estimated total presentation quantities.

In some embodiments of the present disclosure, the apparatus 600 may optionally further include a relationship parameter calculating module 605. The relationship parameter calculating module 605 is configured to calculate a relationship parameter between the search parameter and the actual total presentation quantity when the first service object is searched for using a search keyword and then displayed.

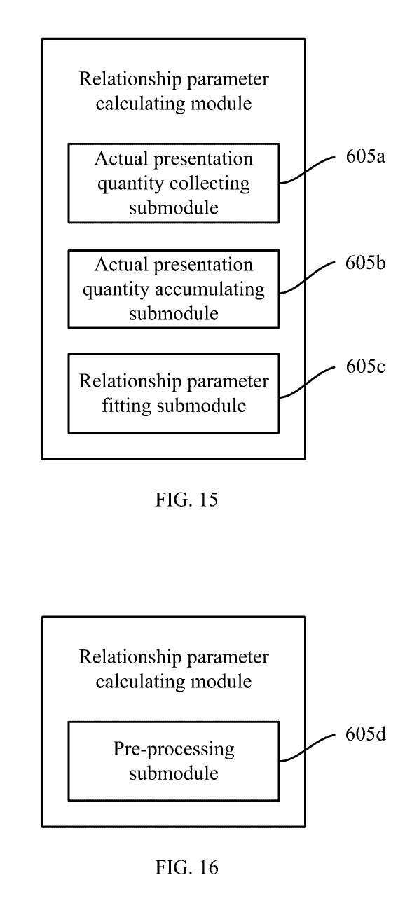

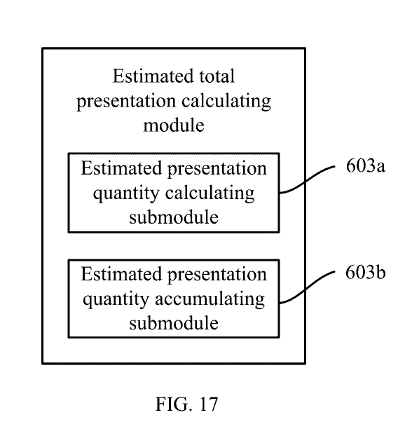

In some embodiments of the present disclosure, the relationship parameter calculating module may include the following submodules illustrated in FIG. 15.

An actual presentation quantity statistical collecting submodule 605a is configured to statistically collect at least one presentation zone of the first service object in at least one presentation page according to log data. The actual presentation quantity statistical collecting submodule 605 is also configured to search for the first service object using a search keyword and determine an actual presentation quantity.

An actual presentation quantity accumulating submodule 605b is configured to accumulate the actual presentation quantities to acquire an actual total presentation quantity.

A relationship parameter fitting submodule 605c is configured to fit a relationship parameter between the search keyword and the actual total presentation quantity.

In some embodiments of the present disclosure, the relationship parameter calculating module may further include a pre-processing submodule 605d configured to pre-process log data, as illustrated in FIG. 16. The pre-processing comprises one or both of eliminating noise data and clearing invalid data according to a geographic location.

In some embodiments of the present disclosure, the estimated total presentation quantity calculating module 603 may include the following submodules.

An estimated presentation quantity calculating submodule 603a is configured to calculate a plurality of estimated presentation quantities using the first parameter value and the one or more second parameter values according to each relationship parameters.

An estimated presentation quantity accumulating submodule 603b is configured to accumulate the plurality of estimated presentation quantities with respect to the first parameter value and the one or more second parameter values to acquire the plurality of estimated total presentation quantities.

In some embodiments of the present disclosure, the client may fit the relationship curve by including and invoking a first fitting submodule. The first fitting submodule is configured to fit the relationship curve between the search parameter and the estimated total presentation quantity by using the first parameter value, the one or a plurality of second parameter values and the plurality of estimated total presentation quantities according to a linear relationship.

In some embodiments of the present disclosure, the client may further fit the relationship curve by including and invoking a second fitting submodule. The second fitting submodule is configured to fit a relationship curve between the search parameter and the estimated total presentation quantity using a first slope within an adjacent zone of a first target parameter value. The first target parameter value is a search parameter having a highest value when a second service object is presented, the second service object being a service object other than the first service object, and the first slope is smaller than a predetermined first slope threshold.

In some embodiments of the present disclosure, the client may further fit the relationship curve by including and invoking a third fitting submodule. The third fitting submodule is configured to fit a relationship curve between the search parameter and the estimated total presentation quantity using a second slope within an adjacent zone of a second target parameter value. The second target parameter value is a search parameter having a lowest value when a second service object is presented, the second service object being a service object other than the first service object, and the second slope is greater than a predetermined second slope threshold.

In some embodiments, the search parameter may be used to calculate a rank score of a searched service object, and one or more service objects having a highest rank score are selected for presentation.

The search parameter may include a permission parameter, and a product of the permission parameter, a pre-calculated quality parameter, and a pre-calculated estimated click through rate is a rank score.

In some embodiments, the first parameter value and the one or more second parameter values are values of the search parameter, and the first parameter value is different from the one or more second parameter values.

Since the apparatus embodiments are similar to the method embodiments, only a brief description is given here. The related elements may be referenced in the description of the corresponding elements in the method embodiments.

Various embodiments are described herein in a progressive manner. Descriptions for same or similar parts between the embodiments may be referenced to each other. In each embodiment, the portion that is different from other embodiments is emphasized.

Those skilled in the art shall understand that the embodiments of the present disclosure may be provided as methods, apparatuses, or computer program products. Therefore, hardware embodiments, software embodiments, or a combination of hardware and software embodiments may be used to implement the embodiments of the present disclosure. In addition, the embodiments of the present disclosure may take a form of a computer program product which is implemented on one or more computer-usable storage medium (including, but not being limited to magnet disk storage, CD-ROM, optical memory storage, and the like) with computer-usable program codes stored thereon.

In a typical configuration, the computer device comprises one or more central processing units (CPUs), input/output (I/O) interfaces, network interfaces, and memory. The memory may include computer-readable medium such as a volatile memory, a random access memory (RAM) and/or other forms of nonvolatile memories, such as a read only memory (ROM) or a flash random access memory (flash RAM). An example of the computer-readable medium is the memory. The computer-readable mediums include permanent and non-permanent mediums, and removable and non-removable mediums, which may implement information storage by using any method or technology. The information may be computer-readable instructions, data structures, program modules or other data. Examples of computer storage mediums include, but are not limited to, a phase change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, compact disc read-only memory (CD-ROM), a digital versatile disk (DVD) or other optical storage devices, a magnetic cassette, a magnetic tape magnetic disk storage device or other magnetic storage devices, or any other non-transmission mediums, which may be used to store information that can be accessed by a computing device. According to the definition in this specification, the computer-readable medium does not include a transitory computer-readable medium, such as modulated data signals and carriers.

The embodiments of the present disclosure are described based on the flow diagrams and/or block diagrams of the method, terminal device (system), and computer program product. It should be understood that each flow and/or block in the flow diagrams and/or block diagrams, and any combination of the flows and/or blocks in the flow diagrams and/or block diagrams may be implemented using computer program instructions. These computer program instructions may be provided to a general computer, a dedicated computer, an embedded processor, or processors of other programmable data processing terminal device to generate a machine, enabling the computer or the processors of other programmable data processing terminal devices to execute the instructions to implement an apparatus for implementing specific functions in at least one flow in the flow diagrams and/or at least one block in the block diagrams.

These computer program instructions may also be stored in a computer-readable memory capable of directing a computer or other programmable data processing terminal devices to work in a specific mode, such that the instructions stored on the computer-readable memory implement a product comprising an instruction apparatus, wherein the instruction apparatus implements specific functions in at least one flow in the flow diagrams and/or at least one block in the block diagrams.

These computer program instructions may also be loaded onto a computer or other programmable data processing terminal devices, such that the computer or the other programmable data processing terminal devices execute a series of operations or steps to implement processing of the computer. In this way, the instructions, when executed on the computer or the other programmable data processing terminal devices, implement the specific functions in at least one flow in the flow diagrams and/or at least one block in the block diagrams.

Although preferred embodiments of the present disclosure are described, those skilled in the art may make modifications and variations to these embodiments based on the basic inventive concept of the present disclosure. Therefore, the appended claims are interpreted as covering the preferred embodiments and all such modifications and variations falling within the protection scope of the embodiments of the present disclosure.

Finally, it should be noted that, in this specification, such relationship-related terms as “first” and “second” are only used to differentiate one entity or operation from another entity or operation, but are not intended to require or imply that there is a practical relationship or sequence between these entities or operations. It should be noted that, in this specification, terms “comprises”, “comprising”, “has”, “having”, “includes”, “including”, “contains”, “containing” or any other variation thereof, are intended to cover a non-exclusive inclusion, such that a process, method, article, or terminal device, that comprises, has, includes, contains a list of elements not only includes those elements, but may also include other elements not expressly listed or inherent to such process, method, article, or terminal device. An element proceeded by “comprises a”, “has a”, “includes a”, “contains a” does not, without more constraints, preclude the existence of additional identical elements in the process, method, article, or terminal device.

Although the information presentation method based on a service object and the information presentation apparatus based on a service object according to the present disclosure have been described in detail herein, and the principles and embodiments of the present disclosure have been described with reference to specific embodiments and examples, the above embodiments are described only to help understanding of the method and core idea of the present disclosure. Persons of ordinary skill in the art may make modification or variations to the specific embodiments or disclosure scopes according to the inventive concept of the present disclosure. In conclusion, this specification shall not be understood as limiting the present disclosure.

What is claimed is:

1. A method for presenting information based on a service object, the method comprising:
receiving, at a server, an adjustment request for a search parameter with respect to a first service object from a client device, the adjustment request including a first parameter value;
identifying, at the server, one or more second parameter values;
calculating, at the server, one or more relationship parameters, wherein calculating one or more relationship parameters includes determining a relationship between the search parameter and one or more actual total presentation quantities of the first service object;
calculating, at the server, one or more estimated total presentation quantities using the first parameter value, the one or more second parameter values, and the one or more relationship parameters;
fitting, at the server, a relationship curve between the search parameter and the one or more estimated total presentation quantities based on the first parameter value, the one or more second parameter values, and the one or more estimated total presentation quantities; and
transmitting, from the server, the relationship curve to the client device.

2. The method according to claim 1, further comprising:
collecting, by the server, statistics relating to at least one presentation zone of the first service object in at least one presentation page based on log data;
searching, by the server, for the first service object by using a search keyword;
determining, by the server, one or more actual presentation quantities of the first service object, the one or more actual presentation quantities based on the collected statistics;
accumulating, by the server, the one or more actual presentation quantities to determine one or more actual total presentation quantities of the first service object; and
calculating, by the server, a relationship parameter between the search keyword and one or more actual total presentation quantities.

3. The method according to claim 2, further comprising pre-processing, by the server, the log data, wherein the pre-processing includes one or both of eliminating noise data and removing invalid data based on a geographic location.

4. The method according to claim 1, further comprising:
calculating, by the server, one or more estimated presentation quantities based on the first parameter value and the one or more second parameter values, wherein each of the one or more estimated presentation quantities is calculated based on one or more relationship parameters associated with the one or more estimated presentation quantities; and
accumulating, by the server, the one or more estimated presentation quantities to determine the one or more estimated total presentation quantities.

5. The method according to claim 1, wherein fitting a relationship curve further comprises fitting the relationship curve between the search parameter and the one or more estimated total presentation quantities using the first parameter value, the one or more second parameter values, and the one or more estimated total presentation quantities according to a linear relationship.

6. The method according to claim 5, wherein fitting a relationship curve further comprises fitting a relationship curve between the search parameter and the one or more estimated total presentation quantities using a first slope within an adjacent zone of a first target parameter value, wherein the first target parameter value is a search parameter having a highest value when a second service object is presented and wherein the first slope is smaller than a predetermined first slope threshold.

7. The method according to claim 5, wherein fitting a relationship curve further comprises fitting a relationship curve between the search parameter and the one or more estimated total presentation quantities using a second slope within an adjacent zone of a second target parameter value, wherein the second target parameter value is a search parameter having a lowest value when a second service object is presented, and wherein second slope is greater than a predetermined second slope threshold.

8. The method according to claim 1, further comprising calculating, by the server, a rank score of a plurality of service objects being searched based on the search parameter, and selecting, by the server, one or more service objects having the highest rank scores.

9. The method according to claim 1, wherein the search parameter includes a permission parameter, and wherein a rank score is calculated based on the product of the permission parameter, a pre-calculated quality parameter, and a pre-calculated estimated click through rate.

10. The method according to claim 1, wherein the first parameter value and the one or more second parameter values are values of the search parameter, the first parameter value being different from the one or more second parameter values.

11. A method for presenting information based on a service object, the method comprising:
receiving, from a client, an adjustment request for a search parameter with respect to a first service object, the adjustment request including a first parameter value;
searching, at the server, for one or more relationship parameters corresponding to one or more keywords, a relationship parameter identifying a relationship between the search parameter and one or more actual total presentation quantities when the first service object was previously searched for using one of the one or more keywords and displayed;
calculating, at the server, one or more estimated total presentation quantities using the first parameter value, the one or more second parameter values, and the one or more relationship parameters; and
transmitting, from the server, to the client, the first parameter value, the one or more second parameter values, and the one or more estimated total presentation quantities such that a relationship curve between the search parameter and the one or more estimated total presentation quantities is fitted and presented according to the first parameter value, the one or more second parameter values, and the one or more estimated total presentation quantities.

12. An apparatus for presenting information based on a service object, the apparatus comprising:
a processor; and
a non-transitory memory storing computer-executable instructions therein that, when executed by the processor causes the apparatus to:
receive an adjustment request for a search parameter with respect to a first service object from a client device, the adjustment request including a first parameter value;
identify one or more second parameter values;
calculate one or more relationship parameters, wherein calculating one or more relationship parameters includes determining a relationship between the search parameter and one or more actual total presentation quantities of the first service object;
calculate one or more estimated total presentation quantities using the first parameter value, the one or more second parameter values, and the one or more relationship parameters;
fit a relationship curve between the search parameter and the one or more estimated total presentation quantities based on the first parameter value, the one or more second parameter values, and the one or more estimated total presentation quantities; and
transmit the relationship curve to the client device.

13. The apparatus according to claim 12, wherein the instruction to fit the relationship curve fitting further causes the apparatus to fit the relationship curve between the search parameter and the one or more estimated total presentation quantities using the first parameter value, the one or more second parameter values, and the one or more estimated total presentation quantities according to a linear relationship.

14. The apparatus according to claim 13, wherein the instruction to fit the relationship curve further causes the apparatus to fit the relationship curve between the search parameter and the one or more estimated total presentation quantities using a first slope within an adjacent zone of a first target parameter value, wherein the first target parameter value is a search parameter having a highest value when a second service object is presented, the second service object being a service object other than the first service object, and wherein the first slope is smaller than a predetermined first slope threshold.

15. The apparatus according to claim 13, wherein the instruction to fit the relationship curve causes the apparatus to fit the relationship curve between the search parameter and the one or more estimated total presentation quantities using a second slope within an adjacent zone of a second target parameter value, wherein the second target parameter value is a search parameter having a lowest value when a second service object is presented, the second service object being a service object other than the first service object, and wherein the second slope is greater than a predetermined second slope threshold.

16. An apparatus for presenting information based on a service object, the apparatus comprising:
a processor; and
a non-transitory memory storing computer-executable instructions therein that, when executed by the processor, cause the apparatus to:
receive an adjustment request for a search parameter with respect to a first service object from a client device, the adjustment request comprising a first parameter value;
search for one or more relationship parameters corresponding to one or more keywords, a relationship parameter identifying a relationship between the search parameter and one or more actual total presentation quantities when the first service object was previously searched for using one of the one or more keywords and displayed;
calculate one or more estimated total presentation quantities using the first parameter value, the one or more second parameter values, and the one or more relationship parameters; and
transmit the first parameter value, the one or more second parameter values, and the one or more estimated total presentation quantities to the client device, such that a relationship curve between the search parameter and the one or more estimated total presentation quantities is fitted and according to the first parameter value, the one or more second parameter values, and the one or more estimated total presentation quantities.

17. The apparatus according to claim 16, wherein the instructions further cause the apparatus to calculate a relationship parameter between the search parameter and the one or more actual total presentation quantities when the first service object is searched for using one of the one or more keywords and then displayed.

18. The apparatus according to claim 17, wherein the instruction to calculate the relationship parameter further causes the apparatus to:
collect statistics, relating to at least one presentation zone of the first service object in at least one presentation page based on log data;
search for the first service object using a search keyword;
determine one or more actual presentation quantities of the first service object, the one or more actual presentation quantities based on the collected statistics;
accumulate the one or more actual presentation quantities to determine one or more actual total presentation quantities of the first service object; and
calculate a relationship parameter between the search keyword and the one or more actual total presentation quantities.

19. The apparatus according to claim 17, wherein the instruction to calculate the relationship parameter further causes the apparatus to pre-process log data, wherein the pre-processing includes one or both of eliminating noise data and removing invalid data according to a geographic location.

20. The apparatus according to claim 16, wherein the instruction to calculate one or more estimated total presentation quantities further causes the apparatus to:
calculate one or more estimated presentation quantities based on the first parameter value and the one or more second parameter values, wherein each of the one or more estimated presentation quantities is calculated based on one or more relationship parameters associated with the one or more estimated presentation quantities; and
accumulate the one or more estimated presentation quantities to determine the one or more estimated total presentation quantities.
